(19) United States
(12) Patent Application Publication
(10) Pub. No.: US 2007/0091786 A1
(43) Pub. Date: Apr. 26, 2007

(54) Transmitting data from a mobile station on an uplink in a spread spectrum cellular system

(76) Inventors: Shupeng Li, Middlesex, NJ (US); Sudhir Ramakrishna, New York, NY (US); Ashok Narasimhaiya Rudrapatna, Somerset, NJ (US)

Correspondence Address: WILLIAMS, MORGAN & AMERSON, 10333 RICHMOND, SUITE 1100, HOUSTON, TX, 77042, US

(21) Appl. No.: 11/256,629

(22) Filed: Oct. 21, 2005

(51) Int. Cl. H04J 9/00

(52) U.S. Cl. 370/204

(57) ABSTRACT

The present invention provides a method and an apparatus for a wireless communication between at least one mobile station and a base station in a cellular system. The method comprises providing a desired spreading in time and frequency domains to transmit data using at least two carriers in a transmission on an uplink to the base station. Either the base station may provide an indication to the mobile station to enable the desired spreading, or alternatively, the mobile station may request it. A spread-spectrum cellular system may enable a mobile station to provide a two-dimensional spreading, which distributes spreading in time and frequency directions. A single two-dimensional spreading code or at least two one-dimensional spreading codes may provide a two-dimensional spreading. In this way, in an uplink transmission using a multi-carrier, code division multiple access (MC-CDMA) protocol, by varying the data portions being spread in time and frequency domains a joint spreading may result. The joint spreading may distribute spreading codes in the time and frequency directions to distribute the spreading in a transmission. When using the MC-CDMA protocol, a mobile station may select one or more spreading formats in an uplink transmission that may increase the success rate of the packet transmission. Moreover, use of a particular spreading format in a flexible manner may reduce the packet delay and suppress intra-cell interference.

### FIELD OF THE INVENTION

This invention relates generally to telecommunications, and more particularly, to wireless communications.

### DESCRIPTION OF THE RELATED ART

Wireless communications systems or mobile telecommunication systems typically provide different types of services to various users or subscribers of wireless communication devices. The wireless communication devices may be mobile or fixed units and situated within a geographic region across one or more wireless networks. The users or subscribers of wireless communication devices, such as mobile stations (MSs) or access terminals or user equipment may constantly move within (and outside) particular wireless networks.

A wireless communications system generally includes one or more base stations (BSs) that can establish wireless communications links with mobile stations. Base stations may also be referred to as node-Bs or access networks. To form the wireless communications link between a mobile station and a base station, the mobile station accesses a list of available channels/carriers broadcast by the base station. To this end, a wireless communications system, such as a spread spectrum wireless communications system, may allow multiple users to transmit simultaneously within the same wideband radio channel, enabling a frequency re-use based on a spread spectrum technique.

Many cellular systems, for example, spread-spectrum cellular systems use a Code division multiple access (CDMA) protocol to transmit data in a wireless network consistent with a desired standard, such as IS-95, CDMA2000 or Universal Mobile Telecommunication System (UMTS) based wideband-CDMA (WCDMA). A spread-spectrum cellular system generally provides transmissions associated with one or more mobile stations that a base station may be serving on the downlink (a.k.a. forward (FL) link). As such, transmissions from mobile stations to a single sector (base station) may occur on the uplink (a.k.a. reverse (RL) link).

For establishing a wireless communication in a cellular system, a base station (BS) schedules the transmissions of the various mobile stations (MSs) that it is serving on the MS-to-BS (reverse link, RL). To this end, the base station may send commands to the mobile stations on the BS-to-MS link (forward link, FL). For example, in a particular cellular system, the mobile stations may use time units based radio access commonly referred to as time slots to transmit on the reverse (RL) link to the base station. The time slots are usually quasi-synchronized (e.g., approximately at the slot boundaries) across the mobile stations (MSs) and the base station (BSs).

Likewise, on the reverse link (RL), one or more mobile stations may communicate with a serving base station, for example, in two transmission modes. That is, when communicating on the reverse link, if transmissions to the serving base station from a particular subset of mobile stations interfere with each other at the base station then the mobile stations may be in a first transmission mode called a non-orthogonal mode. For example, use of a CDMA or a multi-carrier CDMA (MC-CDMA) protocol for radio access by the subset of mobile stations to communicate on the reverse link may cause the subset of mobile stations to be in the first transmission mode. In this case, the transmissions to the serving base station from the subset of mobile stations occur on the same frequency bandwidth while utilizing non-orthogonal codes. As a result, the transmissions can not be orthogonal to each other, and thus interfere with each other at the base station. When a mobile station transmits in the non-orthogonal mode, this situation may apply to either pilot (used for demodulation or for SINR estimation) or for bearer/traffic channels or to both channels.

However, if the transmissions from a subset of mobile stations on the reverse link are such that they do not interfere with each other at the serving base station, the subset of mobile stations are characterized as being in a second transmission mode. In the second transmission mode, this subset of mobile stations is referred to as an orthogonal mode. For example, such an orthogonal mode may result for a subset of mobile stations when the subset of mobile stations communicates on the reverse link using Orthogonal Frequency Division Multiplexing (OFDM) as the radio access technique. In this case, the transmissions from the subset of mobile stations being served by a base station occur on different radio frequencies and are orthogonal to one another. Consequently, the transmissions in the second transmission mode do not interfere with each other at the base station. Again, as is the situation in the non-orthogonal mode, this scenario may apply to either pilot or for bearer/traffic channels or to both channels when a mobile station is transmitting in the orthogonal mode. By sending one or more messages on the forward link, a base station (BS) may control the mobile station transmissions in two control modes.

While operating in a MC-CDMA mode, different types of spreading techniques, such as spreading in the frequency domain may be used by mobile stations (MSs). However, when mobile stations in a cellular system use the MC-CDMA mode on the MS-to-BS (reverse link, RL) link transmission; most conventional spreading techniques generally suffer from a high packet error rate. As a result, in the MC-CDMA mode, the system performance of the cellular system drops significantly. For example, an undesired decrease in the success rate of the packet transmission may severely affect the system performance for high velocity mobile users. One example of deterioration in the system performance is increase in the average retransmission number. A user of the MC-CDMA mode may be a low rate user of a voice over Internet Protocol (VoIP) service, thus a packet delay beyond a certain level may become unacceptable. Additionally, in a cellular system, intra-cell interference may result from code word distortion, which may also need some suppression to combat undesired effects associated with the interference.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method is provided for a wireless communication between at least one mobile station and a base station in a cellular system. The method comprises providing a desired spreading in time and frequency domains to transmit data using at least two carriers in a transmission on an uplink to the base station.

In another embodiment of the present invention, a method is provided for a wireless communication between at least one mobile station and a base station in a cellular system.

The method comprises providing an indication to the at least one mobile station to enable a desired spreading in time and frequency domains to transmit data using at least two carriers in a transmission on an uplink to the base station.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a spread-spectrum cellular system, which enables a mobile station to transmit data with a desired spreading on an uplink using at least two carriers, according to one illustrative embodiment of the present invention;

FIG. 2 schematically depicts the desired spreading in time and frequency domains to transmit data using at least two carriers in a transmission on the uplink to the base station from the mobile station shown in FIG. 1, in accordance with one illustrative embodiment of the present invention;

FIG. 3 schematically depicts a two-dimensional spreading, which distributes spreading in time and frequency directions, according to one exemplary embodiment of the present invention; and

FIG. 4 illustrates a stylized representation for implementing a method of uplink transmission that provides a joint spreading to data by varying the data portions being spread in time and frequency domains using a multi-carrier, code division multiple access protocol, in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and an apparatus are provided for a wireless communication between at least one mobile station and a base station in a cellular system. The method comprises providing a desired spreading in time and frequency domains to transmit data using at least two carriers in a transmission on an uplink to the base station. The base station may provide an indication to the mobile station to enable the desired spreading. Alternatively, the mobile station may request an indication for the desired spreading. A spread-spectrum cellular system may enable a mobile station to provide a two-dimensional spreading, which distributes spreading in time and frequency directions. In this way, in an uplink transmission using a multi-carrier, code division multiple access protocol (MC-CDMA), a transmitter associated with the mobile station may provide a joint spreading to data by varying the data portions being spread in time and frequency domains. Consistent with the MC-CDMA protocol, for providing the joint spreading the transmitter may indicate a distribution of spreading codes in the time and frequency directions to distribute the spreading in a transmission. For providing the two-dimensional spreading, in one embodiment, the transmitter may use a single two-dimensional spreading code. Alternatively, the transmitter may use at least two one-dimensional spreading codes to provide the two-dimensional spreading. For example, by cascading at least two one-dimensional spreading codes, the transmitter may form a two-dimensional spreading code. In one embodiment, to form a two-dimensional spreading code of a desired length, the transmitter may use a spreading code of the same length, i.e., the desired length. The spreading code may be selected to provide a desired peak-to-average ratio. When using the MC-CDMA protocol, a mobile station may select one or more spreading formats in an uplink transmission. Use of time and frequency diversity in uplink transmission may increase the success rate of the packet transmission since on average the number of retransmissions may decrease. To a user of the mobile station being in a MC-CDMA mode, the packet delay may reduce. Use of a particular spreading format in a flexible manner may suppress intra-cell interference that generally results from code word distortion.

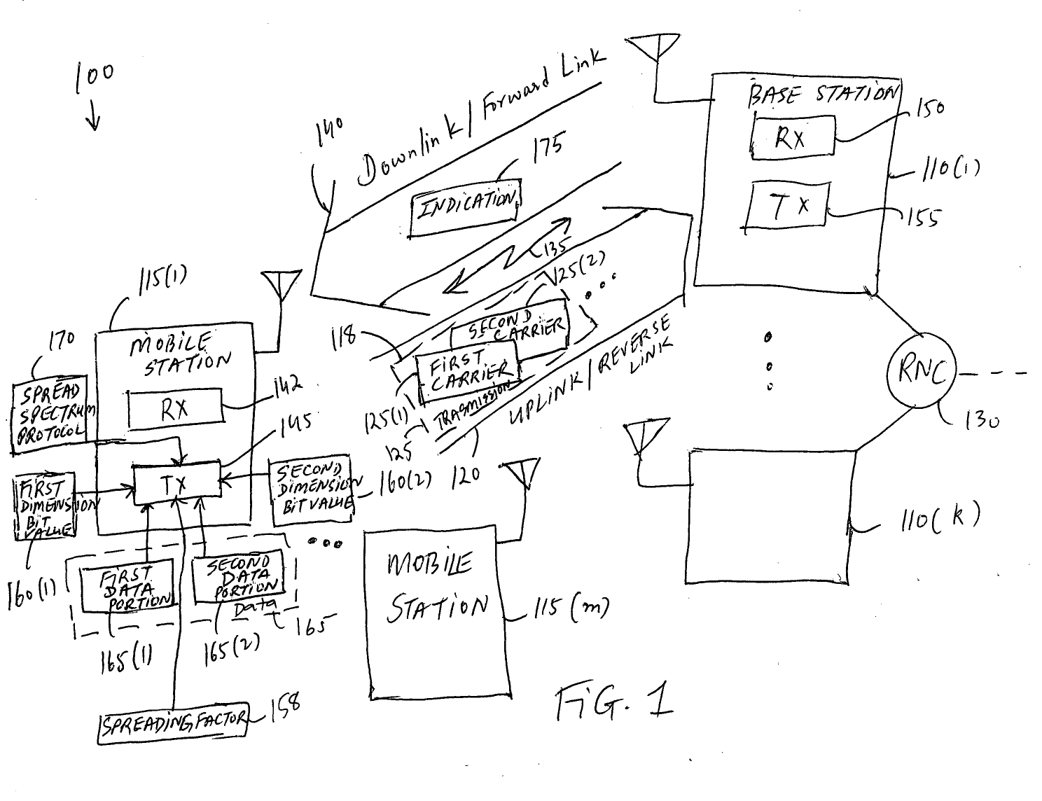

Referring to FIG. 1, a spread-spectrum cellular system 100 is illustrated to include a set of base stations (BSs) 110 (1-k) and a plurality of mobile stations (MSs) 115 (1-m) that may provide a desired spreading in multiple domains for transmitting on an uplink 120 using at least tow carriers according to one illustrative embodiment of the present invention. The set of base stations 110 (1-k) may provide the wireless connectivity to at least one mobile station 115 (1) according to any desirable protocol. Examples of a protocol include a code division multiple access (CDMA, CDMA2000) protocol, wideband-CDMA (WCDMA) protocol, a Universal Mobile Telecommunication System (UMTS) protocol, a Global System for Mobile communications (GSM) protocol, and like.

Examples of the mobile stations 115 (1-m) may include a host of wireless communication devices including, but not limited to, cellular telephones, personal digital assistants (PDAs), and global positioning systems (GPS) that employ the spread spectrum cellular system 100 to operate in a high-speed wireless data network, such as a digital cellular CDMA network. Other examples of the mobile stations 115 (1-m) may include smart phones, text messaging devices, and the like.

In the spread-spectrum cellular system 100, mobile communications that communicate messages between the set of base stations 110 (1-k) and each mobile stations 115 (1-m) may occur over an air interface via a wireless channel 135, such as a radio frequency (RF) medium channel that uses a code division multiple access (CDMA) protocol. Although not shown, the wireless channel 135 may include any intermediate devices that facilitate wireless communication between the mobile stations 115 (1-m) and the set of base stations 110 (1-k). For example, the wireless channel 135 may use a variety of repeaters, antennas, routers, and any desirable communication or network component capable of providing wireless communication. Each mobile station 115 (1-m) may further communicate with the set of base stations 110 (1-k) using the uplink (reverse link) 120 over the wireless channel 135.

A radio network controller 130 may coordinate a handover of mobile communications upon a user leaving an area of responsibility of one base station 110(1), into another base station 110(k). That is, a handover of mobile communications occurs for the mobile station 115(1) when responsibility of communication switches from a first cell sector served by the base station 110(1) to a second cell sector served by the other base station 110(k).

According to one illustrative embodiment of the present invention, the spread-spectrum cellular system 100 may include a frame selector unit (FSU) connected to both the base stations, comparing the frames received by the base stations 110(1) and 110(k) to identify the better frame. This makes it possible for two (or more) base stations of the set of base stations 110(1-k) to seamlessly support the mobile stations 115(1-m).

To communicate with different base stations 110(1-k), the mobile station 115(1) may comprise a receiver (RX) 142 and a transmitter (TX) 145. While the receiver 142 may receive transmissions of packet data from the set of base stations 110(1-k), the transmitter 145 may transmit packet data in transmission 125. The transmission 125 may comprise packet data to the base station 110(1) that may be associated with a cell sector of a base station.

The base station 110(1) may comprise a receiver (RX) 150 and a transmitter (TX) 155 in one embodiment of the present invention. While the receiver 150 may receive transmissions of packet data from the mobile stations 115(1-m), the transmitter 155 may transmit packet data and signaling messages when the base station 110(1) may serve the mobile station 115(1) on the uplink 120. In one embodiment, the mobile station 115(1) may use a code division multiple access (CDMA) protocol, or a multi-carrier CDMA (MC-CDMA) radio access technique to communicate on the uplink 120.

The transmitter 145 may provide a joint time and frequency spreading by the mobile station 115(1) in the spread spectrum wireless cellular system 100, consistent with one embodiment of the present invention. For example, the transmitter 145 may use at least two carriers in a transmission 125 on the uplink 120 to the base station 110(1). One example of such use of multiple carriers in the spread-spectrum cellular system 100 includes a multi-carrier/code division multiple access (MC-CDMA) protocol. In this way, by selectively spreading data 165 in both the time and frequency domains to transmit data, the transmitter 145 may provide the desired spreading by the mobile station 115(1) on the uplink 120 when the mobile station 115(1) deploys the MC-CDMA. The mobile station 115(1) may reduce a packet error rate. This reduction in the packet error rate may significantly increase system performance of the spread-spectrum cellular system 100, in one embodiment.

In one embodiment, the joint time and frequency spreading may apply to a specific frame structure, such as a frame format capable of using at least two sub channels. For example, the frame format may use at least two different transmit formats for a first and a second portion of the transmission 125 from the mobile station 115(1) on the uplink 120 to the base station 110(1). According to one illustrative embodiment of the present invention, the frame format may enable multiplexing of the transmission 125 based on multiple access modes each associated with a different transmit format. For the purposes of transmitting the first portion of the transmission 125, the frame format may use multi-carrier code division multiplexing for the first access mode and may use time and frequency division multiplexing for the second access mode to transmit the second portion thereof. The two portions of the transmission 125 may be separated in temporal, spectral, and/or spatial domains in the uplink 120.

In particular, the transmitter 145 may spread a first data portion 165(1) of the data 165 in the time domain jointly with a second data portion 165(2) of the data 165 in the frequency domain. A spreading factor 158 may define the desired spreading in the transmission 125 in a time and a frequency direction. Based on the spreading factor 158, the transmitter 145 may selectively vary the first and second data portions 165(1,2) of the data 165 in the transmission 125 for providing the desired spreading in the time and frequency domains. In this manner, for a wireless communication between the mobile station 115(1) and the base station 110(1) the success rate of the packet data transmission may significantly increase on the uplink 120.

To provide the desired spreading based on the spreading factor 158 for transmitting data 165 on the uplink 120, the transmitter 145 may use a spread-spectrum protocol 170 and at least two carriers including a first carrier 125(1) and a second carrier 125(2). One example of the first and second carriers 125(1,2) is wireless channels that enable transmission of the data 165 over an air interface between the mobile station 115(1) and the base station 110(1). The spreading factor 158 may utilize spreading codes to spread out the data 165 across time and frequency domains allocated for the transmission 125 on the uplink 120 in the spread-spectrum cellular system 100.

In one embodiment, the base station 110(1) may designate a first number of bits associated with the first data portion 165(1) and a second number of bits associated with the second data portion 165(2) for use by the mobile station 115(1). A different value of a first number of bits then the second number of bits for the second data portion 165(2) may be indicated by the base station 110(1) to each mobile station of a plurality of mobile stations 115. Alternatively, the mobile station 115(1) may request the number of bits associated with the first and second data portions 165(1,2).

More specifically, the mobile station 115(1) may request the base station 110(1) to provide an indication 175 that determines a first bit value and a second bit value of a data block of two-dimensions. The transmitter 145 of the mobile station 115(1) may obtain the first and second bit values of the data block of two-dimensions and apply a time-frequency interleaving to the data block of two-dimensions. In other words, regardless of whether the base station 110(1) designates or provides the indication 175 or the mobile station 115(1) requests the indication 175, a desired spreading in time and frequency domains may be obtained based on the first and second bit values for the data block of two-dimensions. The transmitter 145 may transmit the data block using at least two carriers, such as the first carrier 125(1) and the second carrier 125(2) in the transmission 125 on the uplink 120 to the base station 110(1).

More specifically, an indication 175 may include a first dimension bit value 160(1) and a second dimension bit value 160(2) for two-dimensional bits of the data 165. Based on the first and second dimension bit values 160(1,2), the transmitter 145 may spread the data 165 into at least one two-dimensional block based on a joint time and frequency spreading format. In response to the indication 175, the mobile station 115(1) may use a time and a frequency diversity in the transmission 125 on the uplink 120. In other words, the base station 110(1) may cause the mobile station 115(1) to use a time and a frequency diversity in the transmission 125 on the uplink 120. If the mobile station 115(1) determines whether the indication 175 indicates the transmitter 145 to perform a frequency spread on a portion of the total bandwidth. If so, the mobile station 115(1) may use code hopping for the frequency diversity.

Each mobile station 115 may transmit traffic packets, such as data packets in the transmissions 125. Often the traffic packets include information that is intended for a particular user of a mobile station 115. For example, traffic packets may include voice information, images, video, data requested from an Internet site, and the like. The indication 175 may be intended to be used by the mobile station 115(1), however, other elements of the spread-spectrum cellular system 100 may also use this indication. To this end, the indication 175 may further include configuration messages, setup instructions, switch instructions, handoff instructions, and the like.

In the spread spectrum cellular system 100, a wireless data network may deploy any desirable protocol to enable wireless communications between the base stations 110(1-k) and the mobile stations 115(1-m) according to any desirable protocol. Examples of such a protocol include a (CDMA, WCDMA) protocol, a UMTS protocol, a GSM protocol, and like. The radio network controller (RNC) 130 may be coupled to the base stations 110(1) and 110(k) to enable a user of the mobile station 115(1) to communicate packet data over a network, such as a cellular network. One example of the cellular network includes a digital cellular network based on a CDMA protocol, such as specified by the 3rd Generation (3G) Partnership Project (3GPP) specifications.

Other examples of such a protocol include a WCMDA protocol, a UMTS protocol, a GSM protocol, and like. The radio network controller 130 may manage exchange of wireless communications between the mobile stations 115(1-m) and the base stations 110(1-k) according to one illustrative embodiment of the present invention. Although two base stations 110(1-k) and one radio network controller 130 are shown in FIG. 1, persons of ordinary skill in the pertinent art having benefit of the present disclosure should appreciate that any desirable number of base stations 110 and radio network controllers 130 may be used.

Each of the base stations 110(1-k), sometimes referred to as Node-Bs, may provide connectivity to associated geographical areas within a wireless data network. Persons of ordinary skill in the art should appreciate that portions of such a wireless data network may be suitably implemented in any number of ways to include other components using hardware, software, or a combination thereof. Wireless data networks are known to persons of ordinary skill in the art and so, in the interest of clarity, only those aspects of a wireless data network that are relevant to the present invention will be described herein.

According to one embodiment, each mobile station 115 may communicate with an active base station 110 on the reverse link 120 via the radio network controller 130 coupled to the first and second base stations 110(1-k). Each mobile station 115 may communicate over the uplink 120 with the active base station, which is generally referred to as the serving base station or the serving sector. The 3rd Generation Partnership Project (3GPP) standard defines the role of a serving base station or a serving sector and a serving radio network controller based on 3GPP specifications.

In one embodiment, the uplink 120 and the downlink 140 may be established on a plurality of channels. The channels, such as traffic and control channels may be associated with separate channel frequencies. For example, CDMA channels with associated channel number and frequency may form a wireless communication link for transmission of high-rate packet data. On the downlink 140, for example, the mobile stations 115(1-m) may update the base station 110(1) with a data rate to receive transmissions on a Forward Traffic Channel or a Forward Control Channel. The Traffic Channel carries user data packets. The Control Channel carries control messages, and it may also carry user traffic. The downlink 140 may use a Forward MAC Channel that includes four sub-channels including a Reverse Power Control (RPC) Channel, a Data Rate Control Lock (DRCLock) Channel, ACK channel and a Reverse Activity (RA) Channel.

On the uplink 120, the mobile station 115(1) may transmit on an Access Channel or a Traffic Channel. The Access Channel includes a Pilot Channel and a Data Channel. The Traffic Channel includes Pilot, MAC and Data Channels. The MAC Channel comprises four sub-channels including a Reverse Rate Indicator (RRI) sub-channel that is used to indicate whether the Data Channel is being transmitted on the Reverse Traffic Channel and the data rate. Another sub-channel is a Data Rate Control (DRC) that is used by the mobile station 115(1) to indicate to the first base station 110(1) a data rate that the Forward Traffic Channel may support on the best serving sector. An acknowledgement (ACK) sub-channel is used by the mobile station 115(1) to inform the base station 110(1) whether the data packet transmitted on the Forward Traffic Channel has been received successfully. A Data Source Control (DSC) sub-channel is used to indicate which of the base station sectors should be transmitting forward link data.

In another embodiment, the mobile station 115(1) may provide the transmission 125 of packet data, as shown in FIG. 1, to at least two cell sectors associated with one or more of a set of base stations 110(1-k). In one embodiment, the spread-spectrum cellular system 100 may be based on a cellular network, which at least in part, may be based on a Universal Mobile Telecommunications System (UMTS) standard. The cellular network may be related to any one of the 2G, 3G, or 4G standards that employ any one of the protocols including the UMTS, CDMA2000, or the like, however, use of a particular standard or a specific protocol is a matter of design choice and not necessarily material to the present invention.

In one embodiment, a conventional Open Systems Interconnection (OSI) model may enable transmission of the packet data and other data including messages, packets, datagram, frames, and the like between the mobile station 115(1) and the set of base stations 110(1-k). The term “packet data” may include information or media content that has been arranged in a desired manner. The packet data may be transmitted as frames including, but not limited to, a radio link protocol (RLP) frame, signaling link protocol (SLP) frame or any other desired format. Examples of the packet data may include a payload data packet representative of voice, video, signaling, media content, or any other type of information based on a specific application.

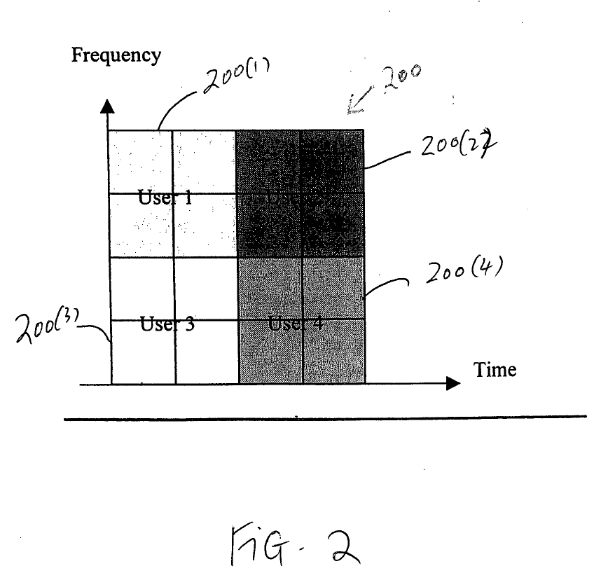

Referring to FIG. 2, a chart schematically depicts a desired spreading 200 in time and frequency domains to transmit the data 165 using at least two carriers 125(1,2) in the transmission 125 on the uplink 120 to the base station 110(1) from the mobile station 115(1) shown in FIG. 1, in accordance with one illustrative embodiment of the present invention. To this end, the transmitter 145 may use a two-dimensional spreading format for the time and frequency domains in the transmission 125 of the data 165.

The data 165, in one example, may include two-dimensional bits. The transmitter 145 may spread the two-dimensional bits of the data 165 into the two-dimensional block 200(1) of a joint time and frequency spreading for a user (1) of the mobile station 115(1). In this way, the spread-spectrum cellular system 100 may provide a joint time and frequency spreading on the uplink 120 for users (1-4) by spreading the two-dimensional bits of user data into a corresponding two-dimensional block 200(1-4), respectively.

For example, the transmitter 145 may enable the desired spreading 200 in a MC-CDMA transmission in both the time and frequency domains. To this end, the transmitter 145 may define the spreading factor 158 in frequency domain as “X” and the one in time domain as “Y.” The transmitter 145 may spread M*N bits of the data 165 for a user into X*Y frequency-time blocks 200(1-4). In the case where X=M*N, Y=1, this spreading is suitable for a MC-CDMA system. While in the case X=1,Y=M*N, this spreading is suitable for a MC-DS-CDMA system.

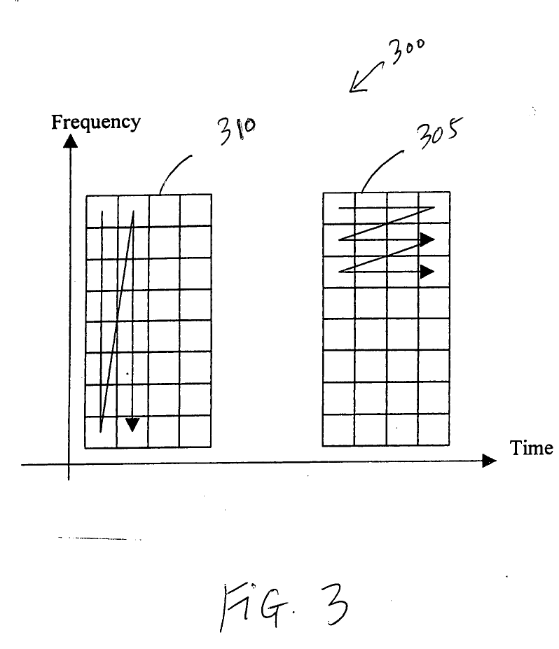

Referring to FIG. 3, a chart schematically depicts a two-dimensional spreading 300 which distributes spreading in time and frequency directions, according to one exemplary embodiment of the present invention. In particular, the two-dimensional spreading 300 comprises a first distribution of spreading 305 in the time direction and a second distribution of spreading 310 in the frequency direction.

In the spread spectrum cellular system 100, such as a code division multiple access (CDMA) protocol based communication or cellular system, the mobile station 115(1) may use spreading codes to provide the desired spreading 200. The spreading codes are generally codes that are used to spread out a data signal to cover the entire frequency spectrum, which is allocated for transmitting data on the uplink 120. For example, in a wideband-CDMA (WCDMA) communication system, spreading codes may spread out a data signal to use the entire wideband spectrum being allocated for data transfer. A spreading code may separate data channels from each other on an air interface in a wireless communication system, such as the spread spectrum cellular system 100. One set of spreading codes may be used on the downlink 140 (a.k.a., forward link) to separate different cells, while another set of spreading codes may separate individual mobile stations 115 in the uplink (a.k.a., reverse link) 120.

For example, the transmitter 145 may enable the two-dimensional spreading 300 in a MC-CDMA transmission to be carried out in both the time and frequency directions using a single two-dimensional spreading code, or using two cascaded one-dimensional spreading codes. The transmitter 145 may form a two dimensional spreading code of Length L from a length L spreading code with chips distributed in time and frequency directions. To form the cascaded spreading codes, the transmitter 145 may use spreading code having a suitable peak-to-average ratio (PAPR) characteristic, for example, complementary Golay code.

A request from a mobile station 115(1) may provide the desired values of M and N. Alternatively, the base station 110(1) may designate the desired values of M and N. However, the M and N used by each mobile station 115 may be different. A desired maximum frequency diversity gain may be achieved with a large M value, in one embodiment. On the other hand, by selecting a small M value, the transmitter 145 may substantially combat code distortion while essentially preserving orthogonality at the base station 110(1). The transmitter 145 may apply a time-frequency interleaving to an M*N data block, such as 200(1). If frequency spreading is performed on part of the total available bandwidth, the mobile station 115(1) may use code hopping to further enhance the frequency diversity.

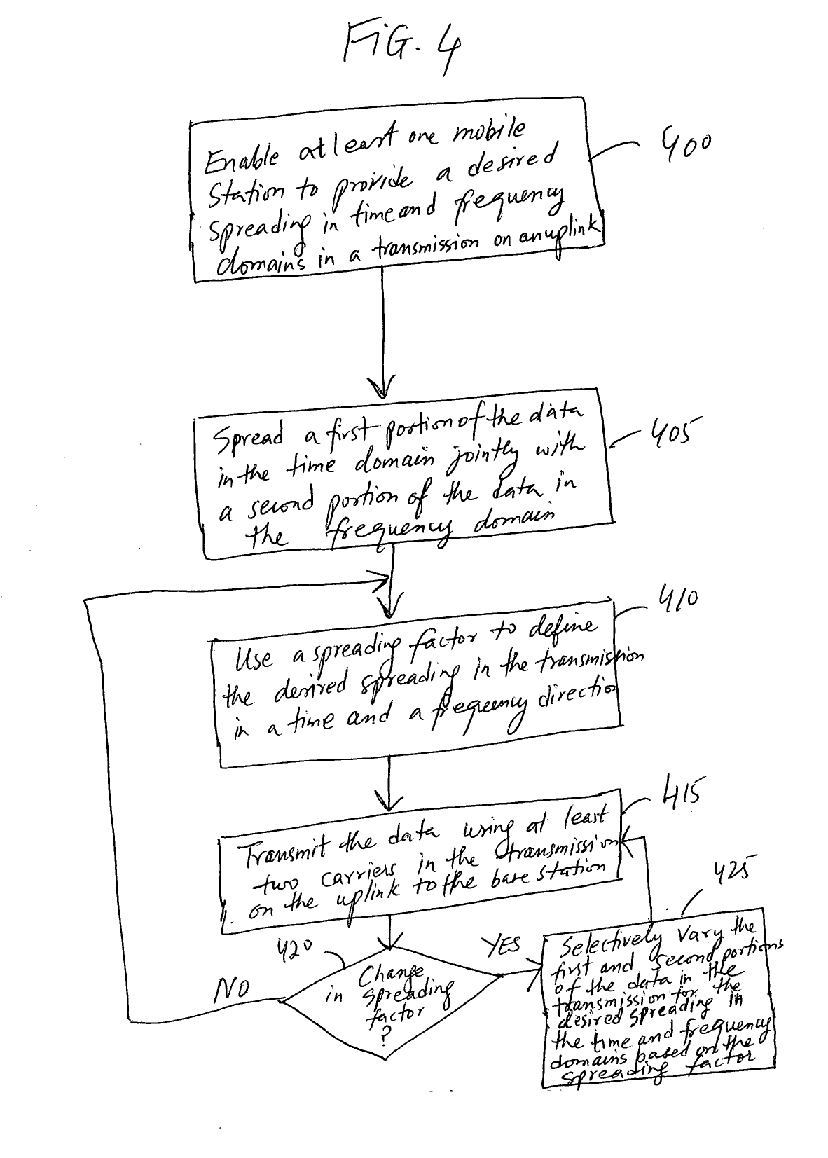

Turning now to FIG. 4, a stylized representation for implementing a method of uplink transmission is illustrated in accordance with one embodiment of the present invention. The method provides a joint spreading by varying the first and second data portions 165(1,2) of the data 165 being spread in time and frequency domains. For transmitting the data 165, the mobile station 115(1) may use a multi-carrier, code division multiple access protocol (MC-CDMA) in the transmission 125.

Accordingly, at block 400, the transmitter 145 may enable at least one mobile station, such as the mobile station 115(1) to provide a desired spreading in time and frequency domains in the transmission 125 on the uplink 120. That is, for transmitting data on the uplink 120 in the spread-spectrum cellular system 100, the mobile station 115(1) may provide spreading in both the time and frequency domains for a wireless communication to the base station 110(1).

At block 405, the transmitter 145 may spread the first data portion 165(1) in the time domain jointly with the second data portion 165(2) of the data 165 in the frequency domain. The spreading factor 158 may define the desired spreading in the transmission 125 in the time and frequency directions, as indicated in block 410. At block 415, the mobile station 115(1) may transmit the data 165 to the base station 110(1) using the first and second carriers 125(1,2) in the transmission 125 on the uplink 120.

A check at a decision block 420, may ascertain whether a change in the spreading factor 158 is indicated. If any change in the spreading factor 158 is indicated at the decision block 420, the transmitter 145 may selectively vary the distribution of the first and second data portions 165(1,2) of the data 165 in the transmission 125 to obtain a desired spreading in the time and frequency domains, as shown at block 425. However, if no change is indicated in the spreading factor 158, the transmitter 145 may continue to use the spreading factor 158, as shown at the block 410.

In one embodiment, in the uplink 120, dedicated physical data control channels (DPDCH/DPCCH) may be spread to a given chip rate using the spreading factor 158. The spreading factor 158 may indicate a user bit rate for a particular service to spread a dedicated physical data control channel in the uplink 120.

In one embodiment, the spread-spectrum cellular system 100 may wirelessly communicate mobile data at a speed and coverage desired by individual users or enterprises. According to one embodiment, the high-speed wireless data network may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP2) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP2) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method of wireless communication between at least one mobile station and a base station in a cellular system, the method comprising:
providing a desired spreading in time and frequency domains to transmit data using at least two carriers in a transmission on an uplink to said base station.

2. A method, as set forth in claim 1, wherein said spreading comprises spreading a first portion of said data in the time domain jointly with a second portion of said data in the frequency domain.

3. A method, as set forth in claim 2, further comprising:
defining the desired spreading in said transmission in a time and a frequency direction based on a spreading factor; and
selectively varying said first and second portions of said data in said transmission for the desired spreading in said time and frequency domains based on said spreading factor.

4. A method, as set forth in claim 1, further comprising:
using a spread-spectrum protocol for transmitting said data on said uplink based on said at least two carriers.

5. A method, as set forth in claim 4, further comprising:
selecting said at least two carriers associated with code division multiple access for the spread-spectrum protocol for said transmission on said uplink from said at least one mobile station.

6. A method, as set forth in claim 5, further comprising:
defining a spreading factor in the frequency domain and the time domain to spread said data in said transmission, wherein said data including two-dimensional one or more bits; and
spreading said two-dimensional one or more bits of said data into two-dimensional one or more blocks of a joint time and frequency spreading.

7. A method, as set forth in claim 1, further comprising:
receiving an indication from said base station; and
in response to said indication, enabling said at least one mobile station to provide said spreading in time and frequency domains to transmit said data.

8. A method, as set forth in claim 1, further comprising:
using a two-dimensional spreading format for said time and frequency domains in said transmission of said data.

9. A method, as set forth in claim 8, further comprising:
using a single two-dimensional spreading code to provide said two-dimensional spreading.

10. A method, as set forth in claim 8, further comprising:
using at least two one-dimensional spreading codes to provide said two-dimensional spreading.

11. A method, as set forth in claim 10, further comprising:
cascading said at least two one-dimensional spreading codes to form a two-dimensional spreading code.

12. A method, as set forth in claim 8, further comprising:
forming a two-dimensional spreading code of a desired length using a spreading code of said desired length, wherein said spreading code having a desired peak-to-average radio.

13. A method, as set forth in claim 12, further comprising:
distributing one ore more chips in a time and a frequency direction.

14. A method, as set forth in claim 13, further comprising:
cascading at least two one-dimensional complementary Golay spreading codes to form said two-dimensional spreading code.

15. A method, as set forth in claim 7, further comprising:
providing a different value of a first number of bits associated with said first portion of said data and a second number of bits associated with said second portion of said data for use by each mobile station of a plurality of mobile stations.

16. A method, as set forth in claim 7, further comprising:
requesting said base station to provide an indication to said mobile station that determines a first bit value and a second bit value of a data block of two-dimensions;
receiving said indication from said base station to obtain said first bit value and said second bit value of said data block of two-dimensions; and
applying a time-frequency interleaving to said data block of two-dimensions.

17. A method, as set forth in claim 7, further comprising:
using a time and a frequency diversity in said transmission on said uplink;
determining whether to perform a frequency spread on a portion of the total bandwidth; and
if so, using code hopping for said frequency diversity.

18. A method of wireless communication between at least one mobile station and a base station in a cellular system, the method comprising:
providing an indication to said at least one mobile station to enable a desired spreading in time and frequency domains to transmit data using at least two carriers in a transmission on an uplink to said base station.

19. A method, as set forth in claim 18, wherein providing an indication to said at least one mobile station further comprises:
including a first dimension bit value and a second dimension bit value of at least one two-dimensional bits of data to spread into at least one two-dimensional block based on a joint time and frequency spreading format.

20. A method, as set forth in claim 19, further comprising:
in response to said indication, causing said at least one mobile station to use a time and a frequency diversity in said transmission on said uplink from said at least one mobile station.
